(19) United States
(12) Patent Application Publication
(10) Pub. No.: US 2023/0040782 A1
(43) Pub. Date: Feb. 9, 2023

(54) PRINT HEAD FOR 3D PRINTER WITH AGILE PRESSURE EXERTION ON THE RAW MATERIAL

(71) Applicant: Robert Bosch GmbH, Stuttgart (DE)

(72) Inventor: Hendrik Jahnle, Leutenbach (DE)

(21) Appl. No.: 17/775,916

(22) PCT Filed: Nov. 11, 2020
(86) PCT No.: PCT/EP2020/081724

§ 371 Date: Oct. 25, 2022

(30) Foreign Application Priority Data
Nov. 11, 2019 (DE) 10 2019 217 358.6

(51) Int. Cl. B29C 64/209; B29C 64/321; B33Y 30/00

(52) U.S. Cl. CPC B29C 64/209; B29C 64/321; B33Y 30/00

(57) ABSTRACT

The invention relates to a print head (10) for a 3D printer (1), comprising a feed (11) for a raw material (20) having variable viscosity and a nozzle (14) which tapers in the flow direction of a liquid phase (22) of the raw material (20) in order to output said liquid phase (22) through an outlet opening (15), wherein at least one pressure generator (12) is provided in order to raise the pressure of at least part of the liquid phase (22) to a base pressure, and wherein at least one pressure modulator (13) connected between the pressure generator (12) and the nozzle (14) is provided in order to modulate the pressure of at least part of the liquid phase (22) about the base pressure.

### BACKGROUND OF THE INVENTION

The present invention relates to a print head for a 3D printer for selectively locally dispensing the liquid phase of the raw material.

A 3D printer for a material of variable viscosity receives a solid phase of this material as the raw material, generates a liquid phase therefrom, and applies this liquid phase selectively at the locations which belong to the object to be generated. Such a 3D printer comprises a print head in which the raw material is prepared so that it is print-ready. Furthermore, means are provided for generating a relative movement between the print head and the working surface on which it is intended to create the object. Either just the print head, just the working surface, or alternatively both the print head and the working surface can thus be moved.

The print head has a first operating state in which liquid material is discharged from it and a second operating state in which no liquid material is discharged from it. The second operating state is, for example, assumed when there is travel to a different position on the working surface and it is intended that no material is deposited on the way to it. It is, for example, possible to switch between the two operating states of the print head by the advance of the solid raw material being switched on and off.

DE 10 2016 222 306 A1 discloses a print head for a 3D printer which receives a granular raw material and delivers it with a piston to the zone in which the raw material is plasticized.

### SUMMARY OF THE INVENTION

Within the scope of the invention, a print head has been developed for a 3D printer. This print head comprises a feeder for a raw material of variable viscosity and a nozzle, tapering in the direction of flow of a liquid phase of the raw material, for dispensing this liquid phase through a discharge opening.

The raw material can be converted into the liquid phase in particular, for example, by a heater attached to the print head. Even if this phase is liquid from a physical point of view, it is typically still viscous enough that it does not pass through the discharge opening of the nozzle of its own accord.

At least one pressure generator is therefore provided in order to elevate the pressure of at least some of the liquid phase to a basic pressure. In addition, at least one pressure modulator, interposed between the pressure generator and the nozzle, is provided in order to modulate the pressure of at least some of the liquid phase around the basic pressure.

The pressure generator can, for example, be a solid operating means which acts on the liquid phase of the raw material, for example a piston. The pressure generator can, however, also comprise, for example, a feeder for compressed air or a different gaseous pressurizing medium. In the case of a 3D printer to which the raw material is fed in the form of a filament, the still solid end of this filament can act on the liquid phase of the raw material in the manner of a piston and in this respect also serve as a pressure generator.

It has been identified that it is important when manufacturing many structures to be able to change the pressure of the raw material quickly. This pressure determines the mass flow which passes per unit time through the discharge opening of the nozzle. This mass flow must always be coordinated with the speed with which the print head and the object to be produced move relative to each other. This means that the pressure of the raw material must track changes in the speed so that exactly the intended amount of material is applied at each location of the object to be produced. The speed changes in particular at points at which the relative movement of the print head and the object to be produced relative to each other markedly changes its direction of movement along at least one axis, or even reverses. In order, for example, to print a right-angled corner, the movement along one side of this corner is decelerated to a halt and then accelerated again along the other side of this corner.

However, when the pressure changes, in particular in the case of plastics and other polymers as raw materials, there are delays between activating corresponding actuators such as, for example, a piston pressurizing the raw material, and actually changing the pressure at the discharge opening of the nozzle. The cause of this is that the said materials are compressible in the liquid phase such that high forces are required for processing them. Furthermore, the shear viscosity of the liquid phase of the raw material also has an influence on the transmission of force. As a result, particularly at the said sharp bends in the contour, at which the speed changes markedly with regard to at least one spatial axis, deviations occur in the applied quantity of material from the planned quantity. This deviation influences the quality and accuracy of the object produced.

Because the total pressure active in the vicinity of the discharge opening is now supplied by the combination of the pressure generator and the pressure modulator, the described delay when the pressure changes can advantageously be minimized.

The shear viscosity is a viscosity which is caused by shearing of the raw material. When the liquid phase of the raw material passes through a nozzle, the rate of flow increases sharply such that shearing occurs. The shearing imparts energy to the raw material and increases its temperature, which in turn influences the viscosity. This change in viscosity can be compensated at least partially by modulating the pressure.

For example, an actuator, which is specially designed to be moved at an average speed and constantly and thus to exert a high total force, can be used for the pressure generator. In contrast, an actuator can, for example, be used which is specially designed for rapid dynamic movements and can exert only a relatively low total force to do this. The advantages of both types of actuator can thus be combined with one another.

Furthermore, by virtue of a suitable structural design of the print head, the volume of liquid raw material on which the pressure modulator acts can be maintained at a much lower level than the volume of liquid raw material on which the pressure generator acts. It has been identified that the delay between the exertion of pressure by the pressure generator or by the pressure modulator, on the one hand, and the change in pressure at the discharge opening of the nozzle, on the other hand, depends on the distance which the force imparted to the liquid phase of the raw material has to cover within this liquid phase. The smaller the distance, the shorter the delay. The distance is linked to the volume of melted material between the pressure modulator and the discharge opening. The volume of melted material can thus be expressed by the distance, and vice versa.

The working position between the pressure generator and the pressure modulator ensures that a volume, reduced for the purpose of a rapid reaction, on which the pressure modulator acts does not unduly affect the throughput of material which can be achieved overall. Thus, for example, the volume on which the pressure generator acts can at the same time also be provided to convert a larger quantity of solid raw material to the liquid phase using a heater. The pressure modulator can then repeatedly “help itself” from this volume.

In a particularly advantageous embodiment, the pressure modulator therefore acts on a partial volume of the liquid phase which has a volume of no more than 1 cm³ and/or which fills a distance of no more than 5 cm between the imparting of the pressure modulation and the discharge opening. Although the distance is linked to the volume, it acts independently, for example via the shear viscosity, in conjunction with the diameter of the region in which the liquid phase of the raw material is situated.

The term “pressure modulator” implies that the pressure of the liquid phase does not need to be increased at all times only above the basic pressure and instead can also be reduced below the basic pressure. This entails additional freedom for the choice of the working point of the pressure generator. For example, this working point can be chosen such that at this pressure an average mass flow of raw material is discharged from the discharge opening. The pressure modulator can then increase or reduce this mass flow. To do this, the pressure modulator can, for example, increase the volume which is available for the liquid raw material enclosed between the pressure modulator and the discharge opening.

In a particularly advantageous embodiment, the pressure modulator is designed to lower the pressure of the liquid phase at the discharge opening to such an extent that the discharge of the liquid phase from the discharge opening is prevented. It is often necessary during the printing process to interrupt the pressure at a certain point and to restart it after a relative movement between the print head and the object to be produced. Interrupting the discharge of raw material from the discharge opening with the pressure modulator is more gentle for the raw material than closing the discharge opening with a valve.

If namely the discharge opening is closed with a valve, this valve increases the flow rate of the liquid phase until the completely closed state is reached. As a result, the raw material is subjected to shearing forces which impart a large amount of energy to the raw material and thus heat it up. The raw material can be damaged by this heating. Furthermore, the shearing forces can also mechanically damage the raw material, for example by polymer chains tearing. The raw material modified by these effects is weakened and literally no longer delivers what it promises. In particular, the viscosity is reduced, which in turn intensifies the damaging effects described.

In a further particularly advantageous embodiment, the pressure modulator comprises a cylindrical needle which is movably mounted in a modulator duct leading to the nozzle and has a tip tapering toward the nozzle. The position of the needle inside the modulator duct then determines the volume which is available for the liquid raw material enclosed between the needle and the discharge opening, and hence also the pressure acting on this raw material.

For this purpose, the spatial arrangement of the pressure generator and its connection to the pressure modulator can in particular be configured such that it provides needle positions in which the needle closes the connection of the pressure modulator to the pressure generator and at the same time encloses liquid raw material between its tip and the discharge opening of the nozzle. The raw material enclosed in such a way is acted on only by a change in pressure by displacement of the needle, whilst this raw material is at the same time not subject to any influence by the pressure generator.

Different types of drive, which each have specific advantages, can be considered for the needle or alternatively any other element used as a pressure modulator. Thus, for example, a motor with a spindle drive has a particularly good price-performance ratio. A stack of piezoelectric elements has particularly fast dynamics. A hydraulic cylinder can exert a maximum force. The drive can moreover be transmitted by any means such as, for example, a lever, a slide, or a gearbox. For example, the forces at the needle can be increased hereby or greater dynamics of the pressure modulation can be obtained with a slower actuator.

In a further particularly advantageous embodiment, the tip is dimensioned such that it can be introduced at least partially into the nozzle. If the tip penetrates in this way particularly far in the direction of the discharge opening, the volume enclosed between the tip and discharge opening can be particularly small. As explained above, the delay is minimized as a result.

In a further particularly advantageous embodiment, the tip is dimensioned such that it can at least partially pass through the discharge opening. In this way, the tip can close the discharge opening, for example during breaks in the printing, or, for example, also clean the discharge opening if solidified raw material and other solids have been deposited there. This increases the efficiency of the 3D printer.

In a further particularly advantageous embodiment, the pressure generator comprises a cylindrical piston which is movably mounted in a main duct which can be filled with the liquid phase. This main duct can then, for example, also be used to melt solid raw material into the liquid phase. When this main duct is, for example, heated, solid raw material added in granular form can be plasticized by the combination of heat from the heater and pressure from the piston.

In a particularly advantageous embodiment, the ratio of the diameter of the needle outside the region of the tip to the diameter of the piston is 1:3 or smaller, preferably 1:4 or smaller. The kinematics of the piston and the modulation of the pressure in the liquid phase of the raw material can then be coordinated with each other particularly well. The associated needle can then also be produced particularly simply and cost-effectively with the necessary strength for the piston diameters typically required in 3D printers.

In a particularly advantageous embodiment, the pressure generator and the pressure modulator act on the liquid phase of the raw material inside a heatable build chamber for the object to be produced and are mechanically coupled to at least one drive source arranged outside the build chamber. Most cost-effective drive sources are designed for operation at a temperature of no more than 60° C. In contrast, it is advantageous if the liquid raw material dispensed from the discharge opening and deposited on the object to be produced does not cool immediately to room temperature and instead only the object produced is cooled as a whole. This improves the cohesion of the printed layers of the object to one another and hence also the mechanical stability of the object as a whole. The object is less distorted mechanically and therefore corresponds more accurately to its specification. This is in particular advantageous when the object needs to, for example, be fitted mechanically to or otherwise engaged mechanically with other components. Temperatures in the range between 60° C. and 100° C. are typically set in the build chamber.

In a further particularly advantageous embodiment, at least some of the region in which the pressure generator can increase the pressure of the raw material has a heater for generating a liquid phase of the raw material. The drive source for the pressure modulator is thermally insulated from this heater. The heated region of the pressure generator can, for example, be thermally encapsulated here. However, for example, the drive source for the pressure modulator can also be thermally encapsulated and optionally cooled too.

### BRIEF DESCRIPTION OF THE DRAWINGS

Further measures which improve the invention are illustrated below in detail with the aid of drawings, together with the description of the preferred exemplary embodiments of the invention.

FIG. 1 shows an exemplary embodiment of a 3D printer with a build chamber for the object to be produced;

FIG. 2 shows an exemplary embodiment of a 3D printer with an insulation between the heated pressure generator and the actuator of the pressure modulator.

### DETAILED DESCRIPTION

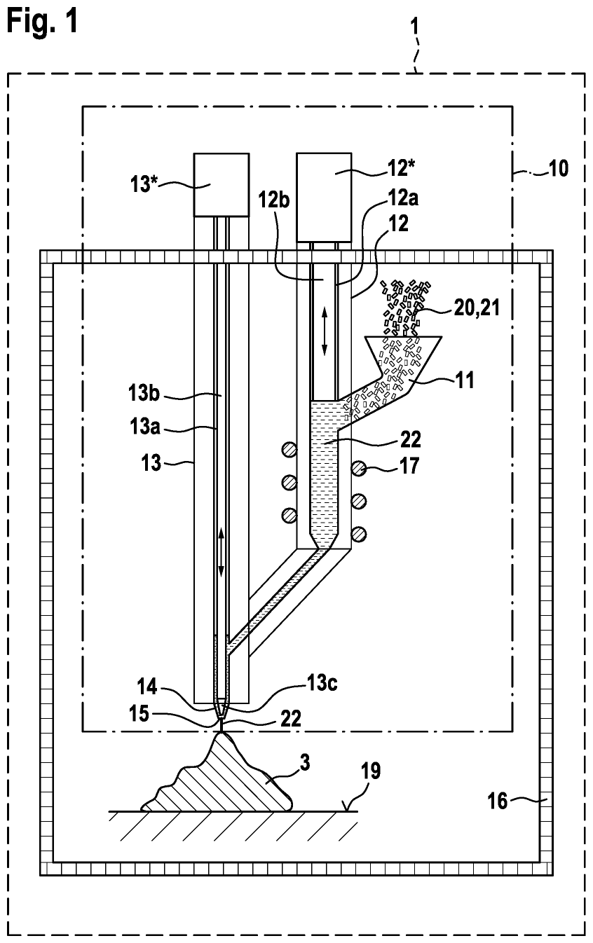

FIG. 1 shows an exemplary embodiment of a 3D printer 1 with the print head 10. The 3D printer 1 has a heatable build chamber 16 for the object 3 to be produced on a build surface 19. The print head 10 comprises components arranged both inside and outside the build chamber 16.

The print head 10 comprises a feeder 11 for the raw material 20 which in this exemplary embodiment is supplied in a granular solid phase 21. The solid phase 21 of the raw material 20 is plasticized to form a liquid phase 22 in a pressure generator 12 provided with a heater 17. The pressure generator 12 comprises a main duct 12a in which a piston 12b is guided and a drive source 12* for the piston 12b. The main duct 12a and the piston 12b are guided through the insulation of the build space 16 to the drive source 12* arranged outside the build space 16.

The pressure generator 12 elevates the pressure of the liquid phase 22 of the raw material 20 to a basic pressure. The print head has a nozzle 14 with a discharge opening 15 through which the liquid phase 22 can be discharged from the print head in the direction of the object 3 to be produced. Starting from the basic pressure, the pressure of the liquid phase 22 is modulated by the pressure modulator 13 interposed between the pressure generator 12 and the nozzle 14. This pressure modulator 13 comprises a modulator duct 13a in which a needle 13b with a tip 13c tapering toward the nozzle 14 is guided. The needle 13b can here enclose in particular a portion of the liquid phase 22 between it and the discharge opening 15. As indicated in FIG. 1, this portion can here not be subject in particular to further influence by the pressure from the pressure generator 12. The pressure modulator 13 can thus increase but also decrease the pressure of the said portion in order, for example, to temporarily prevent the dispensing of liquid raw material 22. It can consequently in particular be avoided, for example, that threads are pulled from liquid raw material 22 discharged undesirably from the discharge opening 15 in the case of lateral movements between the print head 10 and the object 3 to be produced.

The duct 13a and the needle 13b are guided through the insulation of the build space 16 to the drive source 13* arranged outside the build space 16. Beyond this insulation, the temperature of the needle 13b falls quickly. If therefore some of the liquid phase 22 of the raw material 20 penetrates an intermediate space between the needle 13b and the modulator duct 13a owing to an imprecise fit, this material very quickly becomes so viscous that it cannot penetrate the drive source 13*.

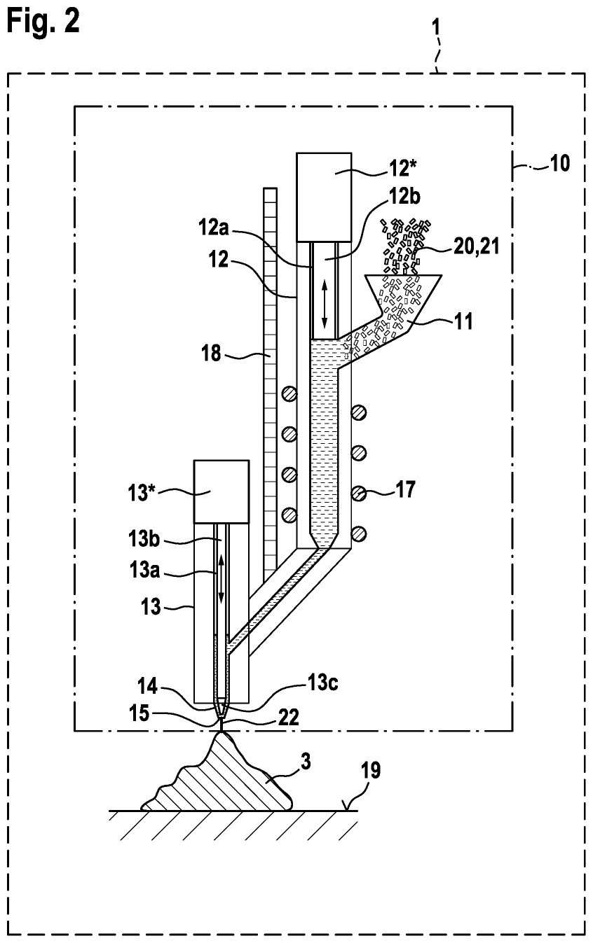

FIG. 2 shows a further exemplary embodiment of a 3D printer 1 with the print head 10. In contrast to FIG. 1, in this exemplary embodiment there is no thermally insulated build space 16. Instead, the build plate 19 for the object 3 to be produced is at room temperature. In a similar fashion to FIG. 1, that part of the pressure generator 12 which can be filled with the liquid phase 22 of the raw material 20 can be heated with a heater 17. The drive source 13* of the pressure modulator 13 is then protected by a thermal insulation 18 from the heat emitted by the heater 17.

1. A print head (10) for a 3D printer (1), with a feeder (11) for a raw material (20) of variable viscosity and with a nozzle (14), tapering in a direction of flow of a liquid phase (22) of the raw material (20), for dispensing the liquid phase (22) through a discharge opening (15), wherein at least one pressure generator (12) is provided in order to elevate a pressure of at least some of the liquid phase (22) to a basic pressure, and wherein at least one pressure modulator (13), interposed between the pressure generator (12) and the nozzle (14), is configured to modulate the pressure of at least some of the liquid phase (22) around the basic pressure.

2. The print head (10) as claimed in claim 1, wherein the pressure modulator (13) acts on a partial volume of the liquid phase (22) which has a volume of no more than 1 cm³ and/or which fills a distance of no more than 5 cm between imparting of the pressure modulation and the discharge opening (15).

3. The print head (10) as claimed in claim 1, wherein the pressure modulator comprises a cylindrical needle (13b) which is movably mounted in a modulator duct (13a) leading to the nozzle (14) and has a tip (13c) tapering toward the nozzle (14).

4. The print head (10) as claimed in claim 3, wherein the tip (13c) is dimensioned such that the tip can be introduced at least partially into the nozzle (14).

5. The print head (10) as claimed in claim 4, wherein the tip (13c) is dimensioned such that the tip can at least partially pass through the discharge opening (15).

6. The print head (10) as claimed in claim 1, wherein the pressure generator (12) comprises a cylindrical piston (12b) which is movably mounted in a main duct (12a) which can be filled with the liquid phase (22).

7. The print head (10) as claimed in claim 6, wherein the pressure modulator comprises a cylindrical needle (13b) which is movably mounted in a modulator duct (13a) leading to the nozzle (14) and has a tip (13c) tapering toward the nozzle (14), wherein the ratio of a diameter of the needle (13b) outside a region of the tip (13c) to the diameter of the piston (12b) is 1:3 or smaller.

8. The print head (10) as claimed in claim 1, wherein the pressure generator (12) and the pressure modulator (13) act on the liquid phase (22) inside a heatable build chamber (16) of the 3D printer (1) for the object (3) to be produced and are mechanically coupled to at least one drive source (12*, 13*) arranged outside the build chamber (16).

9. The print head (10) as claimed in claim 1, wherein at least some of a region in which the pressure generator (12) can increase a pressure of the raw material (20) has a heater (17) for generating a liquid phase (22) of the raw material (20) and the drive source (13*) for the pressure modulator (13) is thermally insulated (18) from this heater (17).

10. The print head (10) as claimed in claim 1, wherein the pressure modulator (13) is configured to lower the pressure of the liquid phase (22) at the discharge opening (15) to such an extent that the discharge of the liquid phase (22) from the discharge opening (15) is prevented.

11. The print head (10) as claimed in claim 7, wherein the tip (13c) is dimensioned such that the tip can be introduced at least partially into the nozzle (14).

12. The print head (10) as claimed in claim 11, wherein the tip (13c) is dimensioned such that the tip can at least partially pass through the discharge opening (15).

13. The print head (10) as claimed in claim 6, wherein the pressure modulator comprises a cylindrical needle (13b) which is movably mounted in a modulator duct (13a) leading to the nozzle (14) and has a tip (13c) tapering toward the nozzle (14), wherein the ratio of a diameter of the needle (13b) outside a region of the tip (13c) to the diameter of the piston (12b) is 1:4 or smaller.

14. The print head (10) as claimed in claim 13, wherein the tip (13c) is dimensioned such that the tip can be introduced at least partially into the nozzle (14).

15. The print head (10) as claimed in claim 14, wherein the tip (13c) is dimensioned such that the tip can at least partially pass through the discharge opening (15).
